(19) United States
(12) Patent Application Publication
(10) Pub. No.: US 2014/0020067 A1
(43) Pub. Date: Jan. 16, 2014

(54) APPARATUS AND METHOD FOR CONTROLLING TRAFFIC BASED ON CAPTCHA

(71) Applicants: Deok-Jin KIM, Daejeon (KR); Byoung-Jin HAN, Suwon-si (KR); Chul-Woo LEE, Daejeon (KR); Man-Hee LEE, Daejeon (KR); Byung-Chul BAE, Daejeon (KR); Hyung-Geun OH, Daejeon (KR); Ki-Wook SOHN, Daejeon (KR)

(72) Inventors: Deok-Jin KIM, Daejeon (KR); Byoung-Jin HAN, Suwon-si (KR); Chul-Woo LEE, Daejeon (KR); Man-Hee LEE, Daejeon (KR); Byung-Chul BAE, Daejeon (KR); Hyung-Geun OH, Daejeon (KR); Ki-Wook SOHN, Daejeon (KR)

(73) Assignee: Electronics and Telecommunications Research Institute, Daejeon (KR)

(21) Appl. No.: 13/607,762

(22) Filed: Sep. 9, 2012

(30) Foreign Application Priority Data
Jul. 11, 2012 (KR) 10-2012-0075630

(51) Int. Cl. G06F 21/00

(52) U.S. Cl. 726/4

(57) ABSTRACT

An apparatus and method for controlling traffic based on a Completely Automated Public Turing test to tell Computers and Humans Apart (CAPTCHA) are provided. The traffic control apparatus includes a traffic monitoring unit, a CAPTCHA verification unit, a list management unit, and a traffic control unit. The traffic monitoring unit monitors a packet between an internal network and an external network. The CAPTCHA verification unit, if packet information is not present in an access control list, sends a CAPTCHA request message to a client computer, receives a CAPTCHA response message, and verifies the CAPTCHA response message. The list management unit, if the packet information is present in the access control list, detects an access control policy corresponding to the packet information in the access control list. The traffic control unit controls traffic based the verification of the CAPTCHA response message and the control policy.

### CROSS REFERENCE TO RELATED APPLICATION

This application claims the benefit of Korean Patent Application No. 10-2012-0075630, filed on Jul. 11, 2012, which is hereby incorporated by reference in its entirety into this application.

### BACKGROUND OF THE INVENTION

1. Technical Field

The present invention relates generally to an apparatus and method for controlling traffic based on a Completely Automated Public Turing test to tell Computers and Humans Apart (CAPTCHA) and, more particularly, to an apparatus and method for controlling traffic based on a CAPTCHA, which learn information about the use of the Internet of users and prevent the internal data of the users from being illegitimately transferred to the outside by malware using the results of the learning and a CAPTCHA.

2. Description of the Related Art

Security accidents occur in which a user's data is illegitimately transferred to the outside by malware without the user being aware of it. In order to prevent such accidents, currently antivirus technologies, Intrusion Detection System (IDSs) technologies and Data Leakage/Loss Prevention (DLP) technologies are being used.

Antivirus technologies and network IDS technologies are technologies that are capable of defending against external attacks. Here, antivirus technologies detect external malware that is being installed or running on a user's computer. Network IDS technologies check whether malicious traffic is present in traffic flowing from the outside to the interior of a system by investigating the network traffic.

These technologies have signature information that is used to identify malware and malicious traffic. These technologies, if a malware that matches the signature information is present in memory or a file or if malicious traffic that matches the signature information is present in a network packet, detect the malware or malicious traffic and then prevent it from operating.

Meanwhile, network DLP technologies analyze the network protocols that are used to transfer a user's internal data, analyze traffic being transferred to the outside based on the results of the former analysis, and detect the transfer of internal data.

Korean Unexamined Patent Application Publication No. 2011-0059963 discloses a malicious traffic blocking apparatus and method and a malicious traffic blocking system using the same. In this technology, when the amount of traffic transferred from a client to a service server exceeds a preset amount, an abnormal traffic detection signal is generated, the client is identified as a normal client and a zombie client by performing a CAPTCHA authentication, and the traffic generated by the zombie client is determined to be malicious traffic and then blocked. This technology is directed to the protection of the service server, and does not block abnormal traffic generated by the client on a network to which the clients belong to.

The conventional technologies that are used to prevent the illegitimate transfer of internal data have some disadvantages. The antivirus technologies or network IDS technologies that perform detection based on signatures cannot detect the transfer of data that is being made by new malware whose signature information is not yet known. These technologies chiefly focus on defending against attacks coming from the outside for reasons of performance, and are thus not suitable for detecting the illegitimate transfer of internal data to the outside.

### SUMMARY OF THE INVENTION

Accordingly, the present invention has been made keeping in mind the above problems occurring in the prior art, and an object of the present invention is to provide an apparatus and method for controlling traffic based on a CAPTCHA, which learn information about the use of the Internet of users and prevent the internal data of the users from being illegitimately transferred to the outside by malware using the results of the learning and a CAPTCHA.

In order to accomplish the above object, the present invention provides a method of controlling traffic, including checking whether packet information corresponding to a packet transmitted or received between an internal network and an external network is present in an access control list; if the packet information is not present in the access control list, generating a Completely Automated Public Turing test to tell Computers and Humans Apart (CAPTCHA) value corresponding to the packet information; sending a CAPTCHA request message including the CAPTCHA value to a client computer connected to the internal network, and receiving a CAPTCHA response message corresponding to the CAPTCHA request message; and verifying the CAPTCHA response message, and controlling traffic between the internal network and the external network based on results of the verification.

The CAPTCHA request message may include not only the CAPTCHA value but also domain information corresponding to the packet information, and location information.

The receiving a CAPTCHA response message may include providing the CAPTCHA request message to the user of the client computer and receiving the CAPTCHA response message from the user.

The controlling traffic between the internal network and the external network may include updating the access control list with results of verification of the CAPTCHA response message.

The CAPTCHA response message may include information that is used to identify an agent having generated the traffic as an actual human or malware.

In order to accomplish the above object, the present invention provides a method of controlling traffic, including checking whether packet information corresponding to a packet transmitted or received between an internal network and an external network is present in an access control list; if the packet information is present in the access control list, detecting a control policy corresponding to the packet information in the access control list; and controlling traffic between the internal network and the external network based on the control policy.

The access control list may include control policies previously set up based on results of control of traffic, and the source and destination addresses of packets.

In order to accomplish the above object, the present invention provides an apparatus for controlling traffic, including a traffic monitoring unit configured to monitor a packet transmitted or received between an internal network and an external network; a CAPTCHA verification unit configured to, if packet information corresponding to the packet is not present in an access control list, send a CAPTCHA request message corresponding to the packet information to a client computer connected to the internal network, receive a CAPTCHA response message corresponding to the CAPTCHA request message, and verify the CAPTCHA response message; a list management unit configured to, if the packet information is present in the access control list, detect a control policy corresponding to the packet information in the access control list; and a traffic control unit configured to control traffic between the internal network or the external network based on results of verification of the CAPTCHA response message and the control policy.

The CAPTCHA verification unit may generate a CAPTCHA value corresponding to the packet information, and send the CAPTCHA request message including the CAPTCHA value, domain information corresponding to the packet information, and location information.

The CAPTCHA verification unit may receive the CAPTCHA response message, including information that is used to identify an agent having generated the traffic as an actual human or malware, from the user of the client computer.

The apparatus may further include a collection unit for collecting domain information that is required to generate a CAPTCHA value included in the CAPTCHA request message.

The list management unit may manage the access control list by updating the access control list with the results of the verification of the CAPTCHA response message.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing an environment to which an apparatus for controlling traffic based on a CAPTCHA according to an embodiment of the present invention is applied;

FIG. 2 is a diagram schematically illustrating the configuration of the apparatus for controlling traffic based on a CAPTCHA according to the embodiment of the present invention;

FIG. 3 is a flowchart showing a method of controlling traffic generated by the application of a client computer if packet information is not present in an access control list according to an embodiment of the present invention;

FIG. 4 is a flowchart showing a method of controlling traffic generated by the application of a client computer if packet information is present in an access control list according to an embodiment of the present invention; and

FIG. 5 is a diagram showing a process of transmitting and receiving CAPTCHA messages between the traffic control apparatus and the CAPTCHA agent according to an embodiment of the present invention.

### DESCRIPTION OF THE PREFERRED EMBODIMENTS

The present invention will be described in detail below with reference to the accompanying drawings. Repeated descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

An apparatus and method for controlling traffic based on a CAPTCHA according to an embodiment of the present invention will be described in detail with reference to the accompanying drawings.

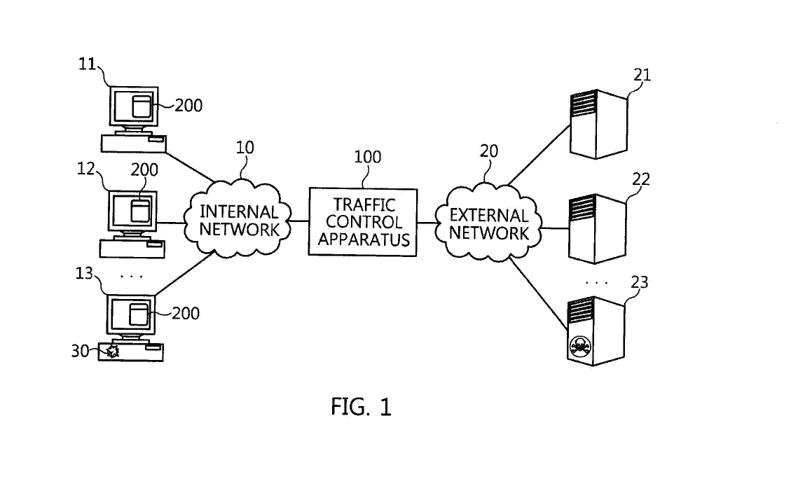

FIG. 1 is a diagram showing an environment to which an apparatus for controlling traffic based on a CAPTCHA according to an embodiment of the present invention is applied.

Referring to FIG. 1, the network environment for controlling traffic based on a CAPTCHA according to the embodiment of the present invention includes a traffic control apparatus 100 located at a network point that connects an internal network 10 and an external network 20, CAPTCHA agents 200 included in a plurality of client computers 11˜13, respectively, that are connected to the internal network 10, and the servers 21-23 of the external network 20.

The traffic control apparatus 100 is located between the internal network 10 and the external network 20, and checks network packets and then determines whether to transfer the corresponding packets to the external network 20. For this purpose, the traffic control apparatus 100 should communicate with the plurality of client computers 11˜13 that are connected to the internal network 10.

When the applications of the client computers 11 and 12 in which malware is not present access the servers 21 and 22 of the external network 20 to which access has been authorized by the traffic control apparatus 100, external services can be utilized in the same manner as when the traffic control apparatus 100 is not established.

In contrast, when the application of the client computer 13 in which malware 30 is present accesses the server 23 of the external network 20 for which no determination has yet been made as to whether to authorize access, the traffic control apparatus 100 generates a CAPTCHA message, and sends the generated CAPTCHA message to the CAPTCHA agent 200 of the client computer 13. Here, the CAPTCHA message is a message that enables a user to identify a packet that was generated without the user's intention, and includes additional information such as the DNS (Domain Name System/Domain Name Server) information of the packet.

Then the CAPTCHA agent 200 displays a CAPTCHA authentication window corresponding to the CAPTCHA message on a screen so that the user can identify whether access has been authorized.

The traffic control apparatus 100 processes the corresponding packet using a CAPTCHA response received from the user via the CAPTCHA authentication window. The CAPTCHA response is learned and then reused. However, the malware 30, other than the user, cannot transfer a CAPTCHA response corresponding to the CAPTCHA message to the traffic control apparatus 100, and thus the corresponding traffic is blocked.

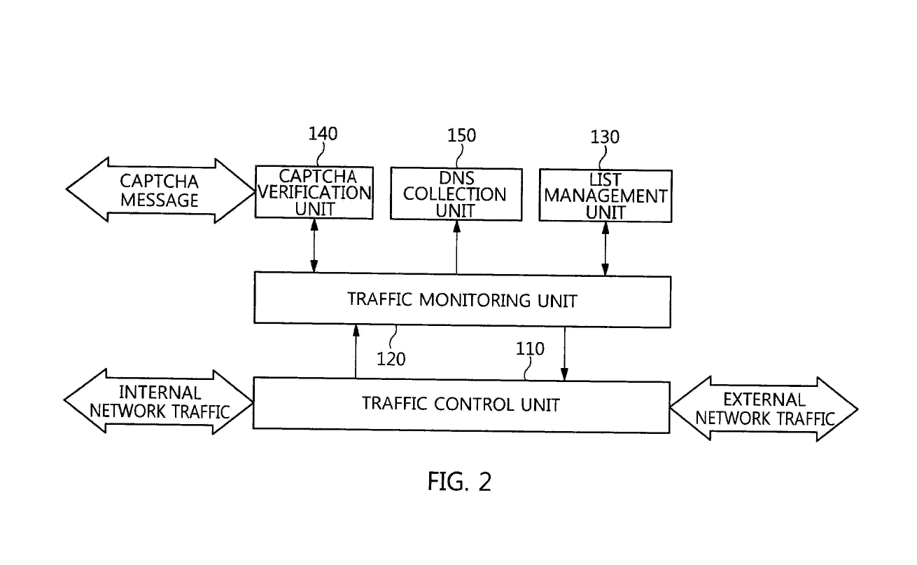

Next, the traffic control apparatus 100 will be described in detail below with reference to FIG. 2.

FIG. 2 is a diagram schematically illustrating the configuration of the apparatus for controlling traffic based on a CAPTCHA according to the embodiment of the present invention.

Referring to FIG. 2, the traffic control apparatus 100 includes a traffic control unit 110, a traffic monitoring unit 120, a list management unit 130, a CAPTCHA verification unit 140, and a DNS collection unit 150.

The traffic control unit 110 lets through or blocks the transmission and reception of packets, that is, traffic, based on control policies that deal with packets transmitted or received between the internal network 10 and the external network 20 and also based on the results of the CAPTCHA verification of the packets.

For example, the traffic control unit 110 delays traffic transmitted from the internal network 10 to the external network 20 first, and transfers all packets transmitted or received between the internal network 10 and the external network 20 to the traffic monitoring unit 120.

The traffic monitoring unit 120 monitors packets controlled by the traffic control unit 110, and transfers packet information corresponding to each of the packets to the list management unit 130 and the CAPTCHA verification unit 140. Next, the traffic monitoring unit 120 receives a control policy corresponding to the packet information from the list management unit 130, or receives the results of verification corresponding to the packet information from the CAPTCHA verification unit 140.

More specifically, the traffic monitoring unit 120 transfers the packet information to the list management unit 130, thereby checking whether the packet information is present in an access control list.

The traffic monitoring unit 120, if the packet information is present in the access control list, transfers the control policies set by the list management unit 130 to the traffic control unit 110.

The traffic monitoring unit 120, if the packet information is not present in the access control list, transfers the packet information to the CAPTCHA verification unit 140, and receives the results of the verification corresponding to the packet information from the CAPTCHA verification unit 140.

Furthermore, the traffic monitoring unit 120 transfers the results of the verification to the list management unit 130, so that traffic having the same source address on the internal network 10 enables traffic having the same destination address on the same external network 20 to be controlled in the same way in the future.

Furthermore, the traffic monitoring unit 120, if packets being monitored include DNS information, transfers the DNS information to the DNS collection unit 150.

The list management unit 130 manages the access control list, and sets up a control policy corresponding to the packet information in the access control list. Here, the access control list includes control policies as well as the information required to control traffic, including the source and destination addresses (IP addresses and ports) of each packet The CAPTCHA verification unit 140 generates a CAPTCHA value corresponding to the packet information received from the traffic monitoring unit 120, and transfers a CAPTCHA request message, including the generated CAPTCHA value, domain information corresponding to the packet information, and packet information-related information, to the client computers 11˜13 of the internal network 10. Thereafter, the CAPTCHA verification unit 140 receives a CAPTCHA response message corresponding to the CAPTCHA request message, verifies the received CAPTCHA response message, and transfers the results of the verification to the traffic monitoring unit 120.

The DNS collection unit 150 manages the DNS information received from the traffic monitoring unit 120. That is, the DNS collection unit 150 manages the DNS information collected from the internal network 10. Here, the DNS information is domain information that is required for the CAPTCHA verification unit 140 to generate the CAPTCHA value.

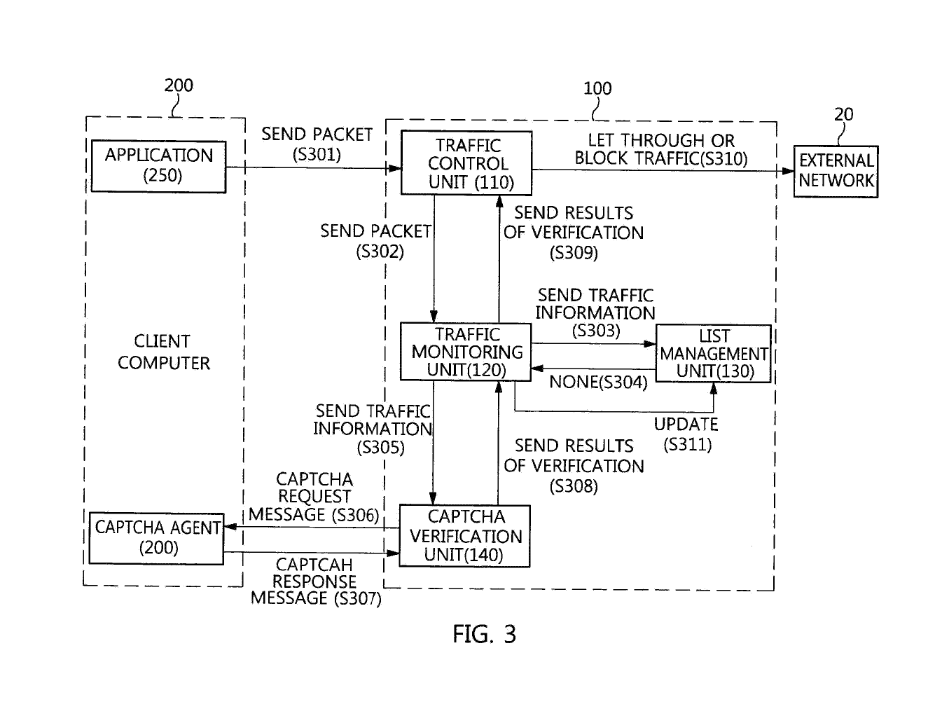

Thereafter, a method by which the traffic control apparatus 100 sends traffic generated by the application of a specific one of the plurality of client computers 11˜13 to the outside using a CAPTCHA will be described in detail below with reference to FIG. 3.

FIG. 3 is a flowchart showing a method of controlling traffic generated by the application of a client computer according to an embodiment of the present invention.

First, the traffic control apparatus 100 is located between the internal network 10 and the external network 20, and controls traffic between the internal network 10 and the external network 20. For this purpose, the traffic control apparatus 100 includes a traffic control unit 110, a traffic monitoring unit 120, a list management unit 130, and a CAPTCHA verification unit 140.

Referring to FIG. 3, the application 250 of the client computer connected to the internal network 10 sends a packet to be sent to a server connected to the external network 20 to the traffic control unit 110 of the traffic control apparatus 100 at step S301.

The traffic control unit 110 delays traffic to be transmitted from the internal network 10 to the external network 20 and sends the packet received at step S301 to the traffic monitoring unit 120 at step S302.

The traffic monitoring unit 120 sends packet information corresponding to the received packet to the list management unit 130 at step S303.

The list management unit 130 checks whether the packet information received at step S303 is present in an access control list stored in advance, and sends a result indicative of the absence of information (“NONE”) to the traffic monitoring unit 120 at step S304.

The traffic monitoring unit 120, if the packet information corresponding to the received packet is not present in the access control list, sends the packet information to the CAPTCHA verification unit 140 at step S305.

The CAPTCHA verification unit 140 generates a CAPTCHA value corresponding to the packet information, and sends a CAPTCHA request message, including the generated CAPTCHA value, domain information corresponding to the packet information and packet information-related information, to the CAPTCHA agent 200 of the client computer at S306.

The CAPTCHA agent 200 of the client computer provides the CAPTCHA request message to the user of the client computer, and receives a CAPTCHA response message from the user. In this case, the user can input a normal CAPTCHA response message, whereas malware cannot input a normal CAPTCHA response message.

Thereafter, the CAPTCHA agent 200 sends the CAPTCHA response message to the CAPTCHA verification unit 140 at step S307.

The CAPTCHA verification unit 140 verifies the CAPTCHA response message and sends the results of the verification to the traffic monitoring unit 120 at step S308. According to this embodiment of the present invention, the results of verification are obtained in such a way that the CAPTCHA verification unit 140 sends a CAPTCHA request message to the CAPTCHA agent 200, receives a CAPTCHA response message from the CAPTCHA agent 200, and performs verification based on the CAPTCHA response message. The results of the verification may be referred to as “CAPTCHA verification results,” and the process may be referred to as a “CAPTCHA verification process.”

The traffic monitoring unit 120 sends the results of the verification received at step S308 to the traffic control unit 110 at step S309.

At step S310, the traffic control unit 110 lets through or blocks the transmission and reception of packets, that is traffic, based on the results of the verification received at step S309.

Furthermore, the traffic monitoring unit 120 sends the results of the verification received at step S308 to the list management unit 130, and manages the results of the verification by causing it to be updated by the list management unit 130 at step S311, thereby enabling traffic having the same source address on the internal network 10 to control (let through or block) traffic having the same destination address on the same external network 20 in the future.

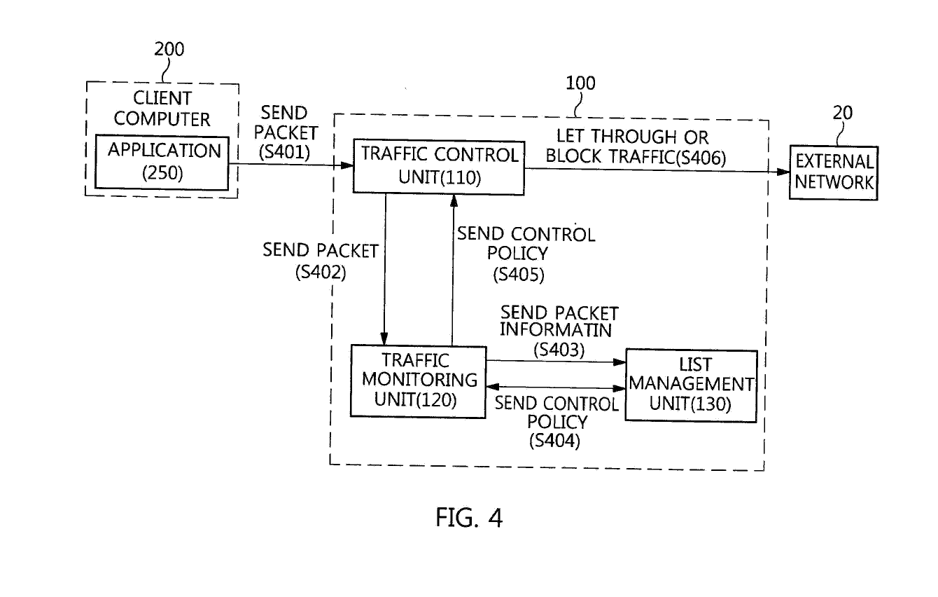

Next, a method by which the traffic control apparatus 100 sends traffic generated by the application of a specific one of the plurality of client computers 11˜13 to the outside based on an access control list including the results of the CAPTCHA verification verified in advance will be described in detail below with reference to FIG. 4.

FIG. 4 is a flowchart showing a method of controlling traffic generated by the application of a client computer according to an embodiment of the present invention.

First, the traffic control apparatus 100 is placed between the internal network 10 and the external network 20, and controls traffic that is transmitted between the internal network 10 and the external network 20. For this purpose, the traffic control apparatus 100 includes a traffic control unit 110, a traffic monitoring unit 120, and a list management unit 130. Here, the list management unit 130 of FIG. 4 includes the access control list as well as the control policies corresponding to packet information in the access control list, unlike the list management unit 130 of FIG. 3.

Referring to FIG. 4, the application 250 of the client computer connected to the internal network 10 sends a packet to be sent to the server connected to the external network 20 to the traffic control unit 110 of the traffic control apparatus 100 at step S401.

The traffic control unit 110 delays the traffic transmitted from the internal network 10 to the external network 20, and sends the packet received at step S401 to the traffic monitoring unit 120 at step S402.

The traffic monitoring unit 120 sends packet information corresponding to the received packet to the list management unit 130 at step S403.

The list management unit 130 checks whether the packet information received at step S303 is present in the access control list stored in advance, and, if, as a result of the checking, it is determined that the packet information is present, sends a control policy corresponding to the packet information to the traffic monitoring unit 120 at step S404.

The traffic monitoring unit 120 transfers the control policy received at step S404 to the traffic control unit 110 at step S405.

At step S406, the traffic control unit 110 lets through or blocks the transmission and reception of packets, that is, traffic, based on the control policy received at step S405 step.

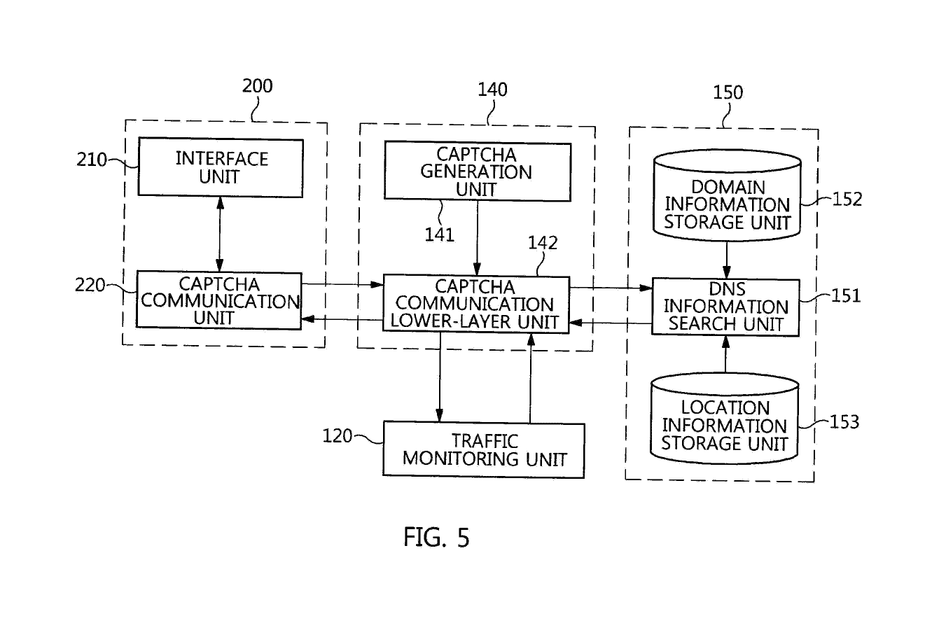

Thereafter, a process of transmitting and receiving CAPTCHA messages (for example, a CAPTCHA request message and a CAPTCHA response message) between the traffic control apparatus 100 and the CAPTCHA agent 200 of the client computer connected to the internal network 10 will be described in detail below with reference to FIG. 5.

FIG. 5 is a diagram showing a process of transmitting and receiving CAPTCHA messages between the traffic control apparatus and the CAPTCHA agent according to an embodiment of the present invention.

Referring to FIG. 5, the CAPTCHA agent 200 includes an interface unit 210 configured to be responsible for interfacing with the user of the client computer and a CAPTCHA communication unit 220 configured to perform communication with the traffic control apparatus 100.

The traffic monitoring unit 120 transfers packet information including information about the client computer to the CAPTCHA verification unit 140.

The CAPTCHA verification unit 140 includes a CAPTCHA creation unit 141 and a CAPTCHA communication lower-layer unit 142.

The CAPTCHA creation unit 141 generates a new CAPTCHA value using the packet information and a specific random number value so that malware cannot respond with a correct value.

The CAPTCHA communication lower-layer unit 142 transfers packet information to the DNS information search unit 151 of the DNS collection unit 150, and receives packet information-related information corresponding to the transferred packet information, that is, domain information and location (country) information, from the DNS information search writ 151. In this way, the DNS information search unit 151 operates in conjunction with the domain information storage unit 152 containing domain information and the location information storage unit 153 containing location (country) information.

Thereafter, the CAPTCHA communication lower-layer unit 142 transfers packet information-related information, that is, domain information and location (country) information, to the CAPTCHA creation unit 141.

The CAPTCHA creation unit 141 generates a CAPTCHA request message including the generated CAPTCHA value and the packet information-related information, and transfers the generated CAPTCHA request message to the CAPTCHA agent 200.

The CAPTCHA communication unit 220 of the CAPTCHA agent 200 receives the CAPTCHA request message, and transfers the CAPTCHA request message to the interface unit 210.

The interface unit 210 displays a CAPTCHA authentication window corresponding to the CAPTCHA request message on the screen of the client computer, and waits for input from the user. In this case, the user selects to let through or block the corresponding traffic, and transfers the results of the selection, that is, a CAPTCHA response message, to the interface unit 210. Thereafter, the interface unit 210 transfers the CAPTCHA response message corresponding to the user's input to the CAPTCHA communication unit 220.

The CAPTCHA communication unit 220 transfers the CAPTCHA response message to the traffic monitoring unit 120 via the CAPTCHA communication lower-layer unit 142. Consequently, the traffic that is blocked by the user and the traffic for which malware does not respond are blocked by the traffic control apparatus 100.

As described above, the present invention is configured to send a CAPTCHA request message to the user so that the user can identify traffic that the user desires to access, and lets through or blocks the connection of the corresponding traffic to the outside in accordance with the CAPTCHA response message corresponding to the CAPTCHA request message. Here, the CAPTCHA request message and the CAPTCHA response message, that is, the CAPTCHA messages, correspond to messages that are used to identify whether an agent that generated the traffic is an actual human or malware. The CAPTCHA message is formed of text, a picture or voice that is intentionally distorted such that a human can identify it but malware cannot identify it. Accordingly, the present invention is configured to accumulate CAPTCHA response messages, learn the results of the control of traffic, and generate an access control list.

The present invention controls the traffic of malware as it attempts to access the outside from inside a corresponding organization, based on the access control list that is generated as described above.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method of controlling traffic, comprising:
checking whether packet information corresponding to each packet transmitted or received between an internal network and an external network is present in an access control list;
if the packet information is not present in the access control list, generating a Completely Automated Public Turing test to tell Computers and Humans Apart (CAPTCHA) value corresponding to the packet information;
sending a CAPTCHA request message including the CAPTCHA value to a client computer connected to the internal network, and receiving a CAPTCHA response message corresponding to the CAPTCHA request message; and
verifying the CAPTCHA response message, and controlling traffic between the internal network and the external network based on results of the verification.

2. The method of claim 1, wherein the CAPTCHA request message includes not only the CAPTCHA value but also domain information corresponding to the packet information, and location information.

3. The method of claim 1, wherein the receiving a CAPTCHA response message comprises providing the CAPTCHA request message to a user of the client computer and receiving the CAPTCHA response message from the user.

4. The method of claim 1, wherein the controlling traffic between the internal network and the external network comprises updating the access control list with results of verification of the CAPTCHA response message.

5. The method of claim 1, wherein the CAPTCHA response message includes information that is used to identify an agent having generated the traffic as an actual human or malware.

6. A method of controlling traffic, comprising:
checking whether packet information corresponding to each packet transmitted or received between an internal network and an external network is present in an access control list;
if the packet information is present in the access control list, detecting a control policy corresponding to the packet information in the access control list; and
controlling traffic between the internal network and the external network based on the control policy.

7. The method of claim 6, wherein the access control list comprises control policies previously set up based on results of control of traffic, and source and destination addresses of packets.

8. An apparatus for controlling traffic executed on one or more processors, comprising:
a traffic monitoring unit loaded on said one or more processors configured to monitor each packet transmitted or received between an internal network and an external network;
a CAPTCHA verification unit loaded on said one or more processors configured to, if packet information corresponding to the packet is not present in an access control list, send a CAPTCHA request message corresponding to the packet information to a client computer connected to the internal network, receive a CAPTCHA response message corresponding to the CAPTCHA request message, and verify the CAPTCHA response message;
a list management unit loaded on said one or more processors configured to, if the packet information is present in the access control list, detect a control policy corresponding to the packet information in the access control list; and
a traffic control unit loaded on said one or more processors configured to control traffic between the internal network and the external network based on results of verification of the CAPTCHA response message or the control policy.

9. The apparatus of claim 8, wherein the CAPTCHA verification unit generates a CAPTCHA value corresponding to the packet information, and sends the CAPTCHA request message including the CAPTCHA value, domain information corresponding to the packet information, and location information.

10. The apparatus of claim 8, wherein the CAPTCHA verification unit receives the CAPTCHA response message, including information that is used to identify an agent having generated the traffic as an actual human or malware, from a user of the client computer.

11. The apparatus of claim 8, further comprising a collection unit loaded on said one or more processors for collecting domain information that is required to generate a CAPTCHA value included in the CAPTCHA request message.

12. The apparatus of claim 8, wherein the list management unit manages the access control list by updating the access control list with results of verification of the CAPTCHA response message.
